(19) United States
(12) Patent Application Publication
(10) Pub. No.: US 2026/0252304 A1
(43) Pub. Date: Aug. 27, 2026

(54) ELECTRONIC DEVICE, METHOD, AND NON-TRANSITORY COMPUTER-READABLE STORAGE MEDIUM FOR ACOUSTIC BEAMFORMING

(71) Applicant: Samsung Electronics Co., Ltd., Suwon-si (KR)

(72) Inventors: Jeonghwan CHOI, Suwon-si (KR); Jaemo YANG, Suwon-si (KR); Hangil MOON, Suwon-si (KR); Kyoungho BANG, Suwon-si (KR); Brian HAN, Suwon-si (KR)

(21) Appl. No.: 19/644,321

(22) Filed: Apr. 10, 2026

Related U.S. Application Data
(63) Continuation of application No. PCT/KR2024/012110, filed on Aug. 14, 2024.

(30) Foreign Application Priority Data
Dec. 5, 2023 (KR) 10-2023-0174982
Jan. 17, 2024 (KR) 10-2024-0007683

(51) Int. Cl. G06F 3/16; H04R 1/22; H04R 1/40; H04R 3/12

(52) U.S. Cl. CPC G06F 3/16; H04R 1/222; H04R 1/406; H04R 3/12; H04R 2499/11

(57) ABSTRACT

An electronic device is disclosed. The electronic device selects at least one sound signal from a sound source DB, generates a first audio signal including a direct sound signal and a reflected sound signal for the at least one sound signal on the basis of a channel impulse response DB, generates an input audio signal in which noise selected from a channel noise DB and the first audio signal are combined, reduces the noise of the input audio signal, generates an output audio signal based on the input audio signal by applying at least one of a beamforming beamwidth or a beamforming direction to the first audio signal of the input audio signal, generates an artificial intelligence (AI) adjustment output audio signal on the basis of applying an AI model to the input audio signal, and causes the AI model to be trained on the basis of reducing the difference between the AI adjustment output audio signal and the output audio signal.

### CROSS-REFERENCE TO RELATED APPLICATION(S)

This application is a continuation application, claiming priority under 35 U.S.C. § 365(c), of an International application No. PCT/KR2024/012110, filed on Aug. 14, 2024, which is based on and claims the benefit of a Korean patent application number 10-2023-0174982, filed on Dec. 5, 2023, in the Ministry of Intellectual Property (MOIP), and of a Korean patent application number 10-2024-0007683, filed on Jan. 17, 2024, in the Ministry of Intellectual Property (MOIP), the disclosure of each of which is incorporated by reference herein its entirety.

### BACKGROUND

### 1. Field

The following description relates to an electronic device, a method, and a non-transitory computer-readable storage medium for acoustic beamforming.

### 2. Description of Related Art

Acoustic beamforming may refer to a technology for obtaining a signal of a sound source in a specific direction among a plurality of sound sources around an electronic device through a microphone array, or for removing/reducing noise other than a sound source in a specific direction.

For example, the electronic device may selectively obtain a sound source signal inputted from a direction of interest, by using a time delay and/or phase delay, according to a distance between microphones in a microphone array.

### SUMMARY

An electronic device is disclosed. The electronic device comprises a plurality of microphones, and a processor, memory storing instructions, wherein the instructions, when executed by the processor, cause the electronic device to encode an input audio signal in time domain received through the plurality of microphones into an input audio signal in a latent domain, based on the input audio signal in the latent domain, identify a mask for performing AI-based beamforming on the input audio signal, and apply the mask to the input audio signal in the frequency domain to obtain an AI-beamformed input audio signal in which at least one of a beamforming direction or a beamforming beamwidth has been applied to the input audio signal.

An electronic device is disclosed. The electronic device comprises a processor, and memory storing a sound source database (DB), a channel impulse response DB for a plurality of microphones, a channel noise DB, and instructions, wherein the instructions, when executed by the processor, cause the electronic device to select at least one sound signal from the sound source DB, based on the channel impulse response DB, generate a first audio signal including a direct sound signal and a reflected sound signal with respect to the at least one sound signal, generate an input audio signal in which noise selected from the channel noise DB and the first audio signal are combined, generate an output audio signal based on the input audio signal by reducing the noise of the input audio signal and applying at least one of a beamforming direction or a beamforming beamwidth to the first audio signal of the input audio signal, generate, based on applying an artificial intelligence (AI) model to the input audio signal, an AI-adjusted output audio signal, and train the AI model based on reducing a difference between the output audio signal and the AI-adjusted output audio signal.

A method is disclosed. The method comprising encoding an input audio signal in time domain received through the plurality of microphones into an input audio signal in a latent domain, based on the input audio signal in the latent domain, identifying a mask for performing AI-based beamforming on the input audio signal, and applying the mask to the input audio signal in the frequency domain to obtain an AI-beamformed input audio signal in which at least one of a beamforming direction or a beamforming beamwidth has been applied to the input audio signal.

A method is disclosed. The method may be executed by an electronic device including memory storing a sound source database (DB), a channel impulse response DB for a plurality of microphones, and a channel noise DB, comprising selecting at least one sound signal from the sound source DB, based on the channel impulse response DB, generating a first audio signal including a direct sound signal and a reflected sound signal with respect to the at least one sound signal, generating an input audio signal in which noise from the channel noise DB and the first audio signal are combined, generating an output audio signal based on the input audio signal by reducing the noise of the input audio signal and applying at least one of a beamforming direction or a beamforming beamwidth to the first audio signal of the input audio signal, generating, based on the applying an artificial intelligence (AI) model to the input audio signal, an AI-adjusted output audio signal, and training the AI model based on reducing a difference between the output audio signal and the AI-adjusted output audio signal.

A computer-readable recording medium is disclosed. The computer-readable recording medium has stored thereon computer-executable instructions which when executed by the computer cause the computer to encode an input audio signal in time domain received through the plurality of microphones into an input audio signal in a latent domain, based on the input audio signal in the latent domain, identify a mask for performing AI-based beamforming on the input audio signal, and apply the mask to the input audio signal in the frequency domain to obtain an AI-beamformed input audio signal in which at least one of a beamforming direction or a beamforming beamwidth has been applied to the input audio signal.

A computer-readable recording medium is disclosed. The computer-readable recording medium has stored thereon computer-executable instructions which when executed by the computer cause the computer to select at least one sound signal from a sound source DB, based on a channel impulse response DB, generate a first audio signal including a direct sound signal and a reflected sound signal with respect to the at least one sound signal, generate an input audio signal in which noise selected from a channel noise DB and the first audio signal are combined, generate an output audio signal based on the input audio signal by reducing the noise of the input audio signal and applying at least one of a beamforming direction or a beamforming beamwidth to the first audio signal of the input audio signal, generate, based on applying an artificial intelligence (AI) model to the input audio signal, an AI-adjusted output audio signal, and train the AI model based on reducing a difference between the output audio signal and the AI-adjusted output audio signal.

### BRIEF DESCRIPTION OF THE DRAWINGS

FIG. 1 is a block diagram of an electronic device in a network environment according to various embodiments.

FIG. 2 is a block diagram of an electronic device according to an embodiment.

FIG. 3 is a diagram illustrating an operation for generating an input audio signal and an output audio signal in an electronic device, according to an embodiment.

FIG. 4 is a diagram illustrating an operation for training an artificial intelligence (AI) model based on an input audio signal and an output audio signal in an electronic device, according to an embodiment.

FIG. 5 is a diagram illustrating an operation for acoustic beamforming an audio signal in an electronic device, according to an embodiment.

FIG. 6 is a diagram illustrating a three-dimensional space around an electronic device.

FIG. 7 is a diagram illustrating an operation of outputting an acoustic beamformed audio signal through an electronic device.

FIG. 8A is a flowchart illustrating an operation in which an electronic device obtains an input audio signal, according to an embodiment.

FIG. 8B is a diagram illustrating a path of an audio signal obtained by an electronic device.

FIG. 8C is a graph illustrating an audio signal obtained in an electronic device, according to a path of an audio signal.

FIG. 9 is a flowchart illustrating an operation in which an electronic device obtains an output audio signal, according to an embodiment.

FIG. 10 is a flowchart for describing an operation in which the electronic device performs acoustic beamforming on an audio signal, according to an embodiment.

### DETAILED DESCRIPTION

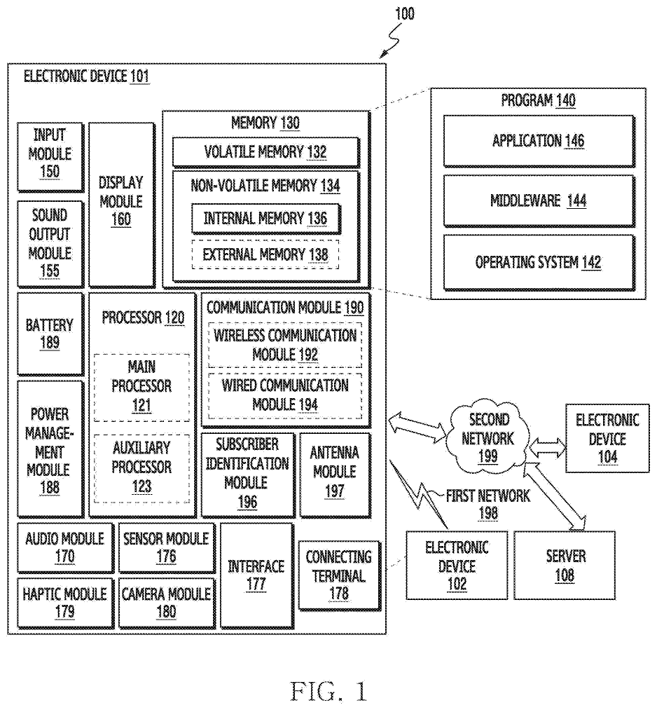

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

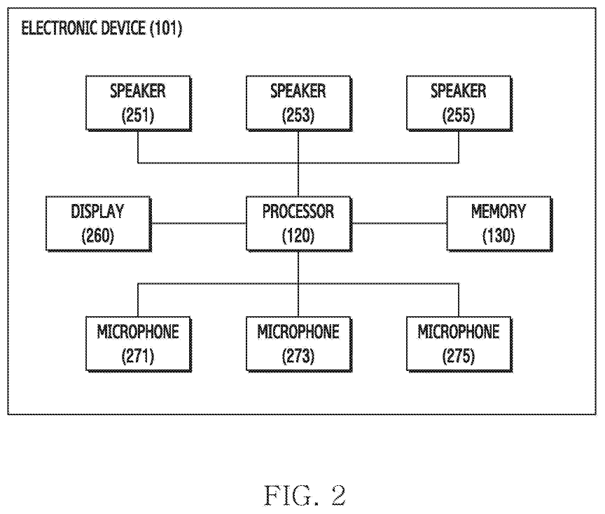

FIG. 2 is a block diagram of an electronic device according to an embodiment.

Referring to FIG. 2, an electronic device 101 may include a processor 120, memory 130, a plurality of speakers 251, 253, and 255, a display 260, and/or a plurality of microphones (mics or mikes) 271, 273, and 275.

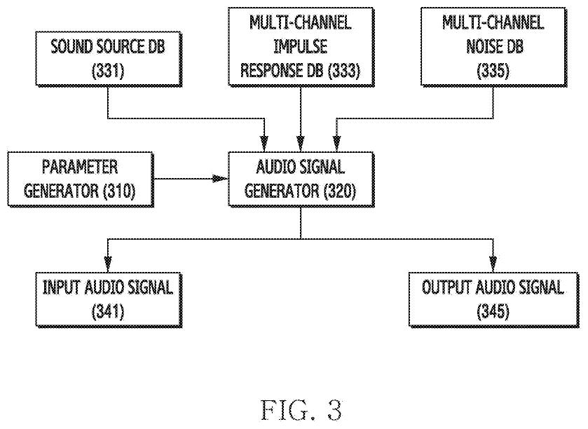

In an embodiment, the processor 120 may be used to execute operations of the electronic device 101 illustrated in the description of FIGS. 3 to 10. For example, the processor 120 may include at least a portion of the processor 120 of FIG. 1 or may correspond to at least a portion of the processor 120 of FIG. 1. For example, the processor 120 may include one or more processors including an application processor (AP) and/or a communication processor (CP). For example, the processor 120 may be implemented as a single chip such as a system on chip (SoC) or a plurality of chips. For example, the processor 120 may be implemented as an integrated circuit or a plurality of integrated circuits. For example, the processor 120 may be arranged in a distributed manner in the electronic device 101.

In an embodiment, the memory 130 may store (at least temporarily) instructions for executing operations of an electronic device 101 illustrated in a description of FIGS. 3 to 10. The instructions may be executed by the processor 120. The instructions may be included in one or more programs stored in the memory 130. For example, the memory 130 may include at least a portion (or at least a portion of the non-volatile memory 134) of the memory 130 of FIG. 1 or may correspond to at least a portion (or at least a portion of the non-volatile memory 134) of FIG. 1. For example, the memory 130 may include a main memory (e.g., a random access memory (RAM)) in the electronic device 101, a register for the processor 120, a cache for the processor 120, a register for a communication circuit 390, a buffer (or a soft buffer) for the communication circuit 390, and/or an auxiliary memory (e.g., a hard disk drive (HDD) or a solid state drive (SSD)) of the electronic device 101. For example, the memory 130 may be implemented as a single chip, or a plurality of chips. For example, the memory 130 may be implemented as an integrated circuit, or a plurality of integrated circuits. For example, the memory 130 may be arranged in a distributed manner in the electronic device 101.

In an embodiment, the plurality of speakers 251, 253, and 255 may output an audio signal to the outside. For example, the plurality of speakers 251, 253, and 255 may include at least a portion of the audio module 170 and/or the sound output module 155 of FIG. 1, or may correspond to at least a portion of the audio module 170 and/or the sound output module 155 of FIG. 1.

In an embodiment, the display 260 may display visual contents. For example, the display 260 may include at least a portion of the display module 160 of FIG. 1, or may correspond to at least a portion of the display module 160 of FIG. 1.

In an embodiment, the plurality of microphones 271, 273, and 275 may be used to obtain (or receive) an audio signal corresponding to a sound obtained from the outside. For example, the plurality of microphones 271, 273, and 275 may include at least a portion of the audio module 170 and/or the sound output module 155 of FIG. 1, or may correspond to at least a portion of the audio module 170 and/or the sound output module 155 of FIG. 1. For example, the plurality of microphones 271, 273, and 275 may include a dynamic microphone, a condenser microphone, and/or a piezo microphone. For example, the plurality of microphones 271, 273, and 275 may be referred to as a microphone array. For example, the plurality of microphones 271, 273, and 275 may be disposed in different positions in the electronic device 101. For example, the plurality of microphones 271, 273, and 275 may obtain an audio signal having different time delay and/or phase delay with respect to a sound signal generated from sound source in a three-dimensional space. Conventional acoustic beamforming may then be implemented by applying predetermined weightings/delays to the signals from each microphone dependent on the intended beamforming direction.

As the number of the plurality of microphones 271, 273, and 275 increases, a beamforming performance may be improved. However, the more microphones 271, 273, and 275 are mounted (or arranged) in the electronic device 101, the higher manufacturing costs may be. Furthermore, increased space is required as the number of microphones increases. Accordingly, there may be a need for a method for improving a beamforming performance, while mounting (or arranging) a small number (e.g., three) of microphones 271, 273, and 275 in the electronic device 101. In other words, it would be advantageous if improved beamforming performance can be achieved without increasing the number of microphones.

Hereinafter, examples for improving a beamforming performance when using a small number of microphones 271, 273, and 275 will be described. In particular, approaches for using an AI model to perform acoustic beamforming are provided along with approaches for generating the training data for training the AI model.

FIG. 3 is a diagram illustrating an operation for generating an input audio signal and an output audio signal in an electronic device, according to an embodiment. In particular, FIG. 3 illustrates an approach for generating artificial input and output audio signals for the training of an AI model that implements acoustic beamforming.

FIG. 3 may be described with reference to FIGS. 1 and 2.

A sound source database (DB) 331, a multi-channel impulse response DB 333, and a multi-channel noise DB 335 illustrated in FIG. 3 may be stored in memory 130. The sound source DB 331, the multi-channel impulse response DB 333, and the multi-channel noise DB 335 may be accessible by the processor 120.

In an embodiment, the sound source DB 331 may include a plurality of different sound signals without noise (or background noise), where the sound signals may include any form of sound signals, such as a voices, animals noises, machinery noise, and music for example. The sound signals may be considered to be original/noise-free sound signals as opposed to sound signals that have been received through a noisy environment. The sounds signals of the sound source DB 331 may also be referred to as a source sound, source sound signal, original sound, original sound signal, clean sound, clean sound signal, noise-free sound, or noise-free sound signal for example.

In an embodiment, the multi-channel (or channel) impulse response DB 333 may include audio signals (or impulse responses, channel impulse response, channel response, channel values/vectors/matrices etc.) measured in each of the plurality (i.e. an array) of microphones 271, 273, and 275, when a sound signal from a sound source (static or dynamic) in a three-dimensional space to the electronic device 101 is directly transmitted (without reflection) to the microphones. In an embodiment, a position of the sound source in the three-dimensional space may be expressed by azimuth angle θ and elevation angle φ when the electronic device 101 is used as the origin. The plurality of microphones 271, 273, and 275 may measure (or obtain) (or record) a sound signal (e.g., sine-sweep signal) occurred (or generated) through an external speaker located within a range of the azimuth angle θ (e.g., 0 to 360 degrees) and a range of the elevation angle φ (e.g., −90 to 90 degrees) with respect to the electronic device 101, in an anechoic environment, so that the audio signal (or impulse response) of the multi-channel impulse response DB 333 may be obtained. However, it is not limited thereto. For example, the audio signal (or impulse response) of the multi-channel impulse response DB 333 may be calculated through an acoustic simulator.

In an embodiment, the multi-channel (or channel) noise DB 335 may include spatially uncorrelated noise (or background noise) signals. In an embodiment, the noise (or background noise) signals of the multi-channel noise DB 335 may include diffuse noise (or later reverberations) and/or microphone self-noise. In an embodiment, the noise (or background noise) signals of the multi-channel noise DB 335 may be signals not related to the sound signals (or voice signals) of the sound source DB 331. For example, the noise (or background noise) signals may be distinguished from signals according to a direct path of the sound signals (or voice signals) of the sound source DB 331 or signals according to a reflection path (e.g., early reflections) of the sound signals (or voice signals) of the sound source DB 331. In an embodiment, the early reflections may be a sound that reaches the electronic device 101 after a sound according to the direct path (or direct sound) is reflected (a small number of times) by a reflector (e.g., a wall, a ceiling, or a floor) in the three-dimensional space. In an embodiment, the late reverberations may be a sound that reaches the electronic device 101 in multiple reflections after the sound according to the direct path (or direct sound) is reflected (a large number of times) by the reflector(s) (e.g., the wall, the ceiling, or the floor) in the three-dimensional space. The multi-channel noise may be statistically generated and/or obtained via the microphones.

A parameter generator 310 and an audio signal generator 320 illustrated in FIG. 3 may be stored as a program in the memory 130. The sound source DB 331, the multi-channel impulse response DB 333, and the multi-channel noise DB 335 may include instructions executable by the processor 120.

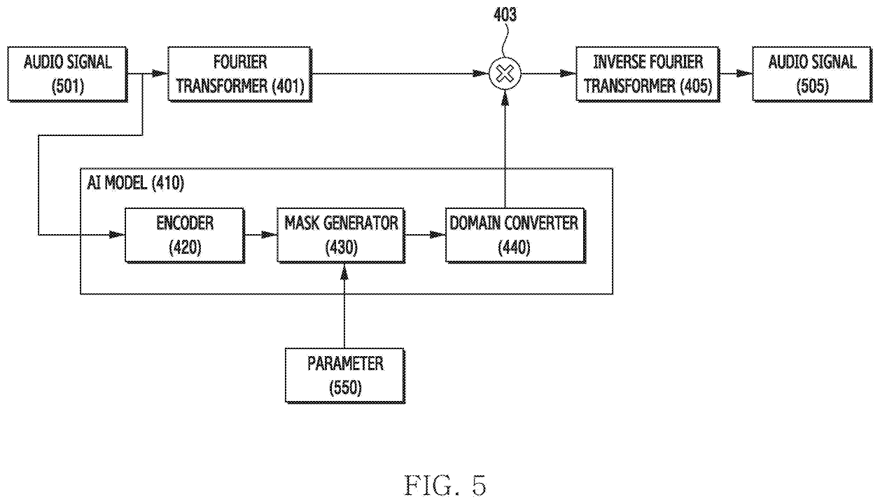

In an embodiment, the parameter generator 310 may generate parameters for adjusting (i.e. steering or changing) a beam associated with a generated (i.e. simulated, synthesized, artificial) audio signal (output audio signal 345 generated by the audio signal generator 320). The parameter generator 310 may also be used to generate parameters when actual beamforming is being performed, as set out with respect to FIG. 5. In an embodiment, the parameters may include parameters for adjusting a direction and/or width of the beam. For example, the direction of the beam may include a direction within the range of the azimuth angle θ (e.g., 0-360 degrees) and the range of the elevation angle φ(e.g., −90 to 90 degrees) with respect to the electronic device 101. For example, the width (or angle) of the beam may represent a width (or angle) in an orientation (or direction) of the beam. For example, the width of the beam may be normalized between 0 and 1.

In an embodiment, the parameter generator 310 may generate a parameter for adjusting (i.e. controlling or changing) a degree of the background noise of the generated audio signal. In an embodiment, the parameter may have a value between 0 and 1 to indicate the degree of the background noise of the generated audio signal.

In an embodiment, the parameter generator 310 may randomly generate parameters related to the beam of the generated audio signal and a parameter related to background noise within a specified range. For example, the parameter generator 310 may randomly generate a direction-related parameter within the range of the azimuth angle θ (e.g., 0-360 degrees) and the range of the elevation angle φ (e.g., −90 to 90 degrees). For example, the parameter generator 310 may randomly generate a parameter related to the beamwidth within a range of 0 to 1. For example, the parameter generator 310 may randomly generate parameters related to the background noise within a range of 0 to 1.

In an embodiment, the audio signal generator 320 may generate the generated audio signals (i.e. the input audio signal 341 and the output audio signal 345) using one or more of the sound source DB 331, the multi-channel impulse response DB 333, the multi-channel noise DB 335, or the parameter generator 310.

Hereinafter, an operation in which the audio signal generator 320 generates the input audio signal 341 will be described.

In an embodiment, the audio signal generator 320 may generate the input audio signal by simulating/calculating an audio signal as if it has been received through the microphones from one or more sound sources in the three-dimensional space using the sound source DB 331 and the multi-channel impulse response DB 333.

In an embodiment, the audio signal generator 320 may generate a sound signal (hereinafter, a direct sound or a direct sound signal) according to the direct path using a sound signal selected from the sound source DB 331 and an impulse response in the three-dimensional space selected from the multi-channel impulse response DB 333. In an embodiment, one or more reflected signals (e.g., early reflections, and/or late reverberations) (hereinafter, a reflected sound) with respect to the direct sound may be generated through one or more impulse responses to the selected sound signal. In an embodiment, a designated time delay, and/or a scaling factor may be applied to the one or more reflected signals.

In an embodiment, the audio signal generator 320 may combine (i.e. synthesize, convolute or mix) the direct sound and the reflected sound to generate a noise-free input audio signal (which may also be referred to as an intermediate input audio signal, first input audio signal etc.). In an embodiment, the audio signal generator 320 may generate the noise-free input audio signal by combining (i.e. synthesizing, convoluting or mixing) one or more direct sounds and one or more reflected sounds with respect to each of the direct sounds. In examples, only directs sounds may be combined.

In an embodiment, the audio signal generator 320 may generate the input audio signal 341 by combining (i.e. synthesizing, convoluting or mixing) noise selected from the multi-channel noise DB 335 with the noise-free input audio signal. In an embodiment, the audio signal generator 320 may generate the input audio signal 341 by combining the noise with the noise-free input audio signal according to a designated signal to noise ratio (SNR).

In an embodiment, the audio signal generator 320 may generate the input audio signal 341 such as in Equation 1 below.

$${y}_{m} ( t ) = {\sum }_{n = 1}^{N} {h}_{m} ( {r}_{n} , t ) * {s}_{n} ( t ) + {ν}_{m} ( t ) \qquad Equation 1$$

In the Equation 1, yₘ(t) may represent an input audio signal 341 obtained at a time point t through the m-th microphone among M microphones. sₙ(t) may represent the n-th sound signal among N sound signals from the sound source DB 331. hₘ(rₙ, t) may represent an impulse response (or room impulse response) from the position rₙ of the n-th sound signal at the time point t to the m-th microphone from the multi-channel impulse response DB 333. vₘ(t) may represent noise (or background noise) obtained at the time point t through the m-th microphone from the multi-channel noise DB 335.

Hereinafter, an operation in which the audio signal generator 320 generates the output audio signal 345 will be described.

In an embodiment, the audio signal generator 320 may generate the output audio signal by simulating/calculating an audio signal as if it has been received though the microphones from the one or more sound sources in the three-dimensional space via beamforming using the sound source DB 331 and the multi-channel impulse response DB 333.

In an embodiment, the audio signal generator 320 may generate a sound signal (hereinafter, the direct sound or a direct sound signal) according to the direct path using the sound signal selected from the sound source DB 331 and the impulse response in the three-dimensional space selected from the multi-channel impulse response DB 333. In an embodiment, the one or more reflected signals (e.g., early reflections, and/or late reversions) (hereinafter, the reflected sound) may be generated through the one or more impulse responses to the selected sound signal. In an embodiment, the designated time delay and/or the scaling factor may be applied to the one or more reflected signals. In an embodiment, the direct sound and the one or more reflected sounds for the output audio signal 345 may be the same as the direct sound and the one or more reflected sounds for the input audio signal 341.

In an embodiment, the audio signal generator 320 may adjust the direct sound and one or more reflected sounds with respect to the direct sound, based on beamforming parameters generated (or selected) using the parameter generator 310. In an embodiment, the audio signal generator 320 may identify a spatial gain that causes an audio signal to have a direction and beamwidth corresponding to the beamforming parameters. In an embodiment, the audio signal generator 320 may adjust the direct sound and the one or more reflected sounds with respect to the direct sound by multiplying the spatial gain by the direct sound and the one or more reflected sounds with respect to the direct sound. In an embodiment, the spatial gain may be set to have a high spatial gain for the selected position (or direction) and beamwidth and a low spatial gain for other positions (or directions) and beamwidths.

In an embodiment, the audio signal generator 320 may combine (i.e. synthesize, convolute or mix) the direct sound applied and the reflected sound each multiplied by the spatial gain to generate a noise-free output audio signal (which may also be referred to as an intermediate output audio signal). In an embodiment, the audio signal generator 320 may generate the noise-free output audio signal by combining (i.e. synthesizing, convoluting or mixing) one or more direct sounds applied (or multiplied) the spatial gain and one or more reflected sounds with respect to each of the direct sounds.

In an embodiment, the audio signal generator 320 may adjust a size of noise selected from the DB 335 based on a parameter related to the noise generated (or selected) using the parameter generator 310. The noise selected in the multi-channel noise DB 335 for the output audio signal 345 may be the same as the noise selected in the multi-channel noise DB 335 for the input audio signal 341.

In an embodiment, the audio signal generator 320 may identify (or determine) a parameter such as Equation 2 below by using the parameter generator 310.

$$d = {[ cos θ cos ϕ , sin θ cos ϕ , sin ϕ , {\tilde{σ}}_{d} , {g}_{v} ]}^{T} ∈ {ℝ}^{5} \qquad Equation 2$$

In the Equation 2, d may represent a parameter generated (or selected) using the parameter generator 310. The cos θ cos φ, sin θ cos φ, and sin φ may represent unit vectors (or parameters related to a direction) based on the azimuth angle θ and elevation angle φ based on the electronic device 101. \tilde{σ}_{d} may represent a parameter related to beamwidth in a range of 0 to 1. gᵥ may represent a parameter related to background noise in a range of 0 to 1.

In an embodiment, the audio signal generator 320 may generate the output audio signal 345 by combining (i.e. synthesizing, convoluting or mixing) a size-adjusted noise with the noise-free output audio signal.

In an embodiment, the audio signal generator 320 may generate the output audio signal 345 such as in Equation 3 below.

$${z}_{m , d} ( t ) = {\sum }_{n = 1}^{N} f ( {h}_{m} ( {r}_{n} , t ) , d ) * {s}_{n} ( t ) + {g}_{v} \cdot ν ( t ) \qquad Equation 3$$

In the Equation 3, z_{m,d}(t) may represent an output audio signal 345 at a time point t through the m-th microphone among M microphones adjusted based on the parameter d. f(hₘ(rₙ, t), d) may represent an impulse response hₘ(rₙ, t) from a position rₙ of the n-th sound signal to the m-th microphone at a time point t from the multi-channel impulse response DB adjusted based on the parameter d. sₙ(t) may represent the n-th sound signal among N sound signals from the sound source DB. gᵥ may represent a parameter related to background noise in a range of 0 to 1. v(t) may represent noise (or background noise) obtained at the time point t from the multi-channel noise DB.

As described above, the output audio signal 345 may be an audio signal in which the beam is adjusted (or steered, changed) in the input audio signal 341 (i.e. a version of the input audio signal to which beamforming has been applied) and/or an audio signal in which noise is reduced. As explained below, the input audio signal and the output audio signal may be used as training data for training an AI model to perform acoustic beamforming. Although the generation of a single input audio signal and a single output audio signal has been described, any number of different pairs of input audio signals and output audio signals may be generated via the selection of different signals and combination of signals from the various databases.

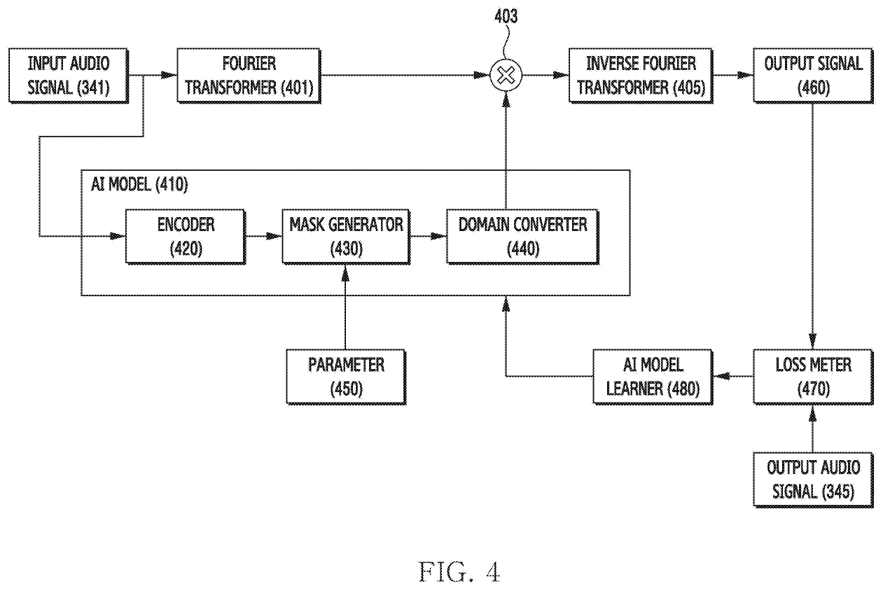

FIG. 4 is a diagram illustrating an operation for training an artificial intelligence (AI) model based on the input audio signal and the output audio signal in an electronic device, according to an embodiment, where the AI model is for implementing acoustic beamforming.

FIG. 4 may be described with reference to FIGS. 1, 2, and 3.

A Fourier transformer 401, an operator 403, and an inverse Fourier transformer 405 illustrated in FIG. 4 may be stored as a program in memory 130. The Fourier transformer 401, the operator 403, and the inverse Fourier transformer 405 may include instructions executable by a processor 120. However, it is not limited thereto. The Fourier transformer 401, the operator 403, and the inverse Fourier transformer 405 may be implemented as a hardware including a circuit.

In an embodiment, the Fourier transformer 401 may convert an input audio signal 341 in the time domain into a signal in the frequency domain. In an embodiment, the Fourier transformer 401 may convert the input audio signal 341 in the time domain into the signal in the frequency domain, based on a designated Fourier transform algorithm (e.g., short time Fourier transform (STFT)).

In an embodiment, the Fourier transformer 401 may convert the input audio signal 341 in the time domain into the signal in the frequency domain with respect to each of a plurality of sample signals of the input audio signal divided by a designated first window length. In an embodiment, two consecutive sample signals may overlap each other by an offset. In an embodiment, a time length (or offset) at which two consecutive sample signals overlap may be half the first window length. For example, in case that the input audio signal 341 is divided into N (N is a natural number) sample signals of a designated first window length, a first half signal of a k-th (k is a natural number below N−1) sample signal overlaps a second half signal of a k−1th sample signal, and a second half signal of the k-th sample signal overlaps a first half signal of the k+1th sample signal. However, it is not limited thereto. A degree of overlap may be set differently.

An artificial intelligence (AI) model 410, a loss meter 470, and an AI model learner 480 illustrated in FIG. 4 may be stored as a program in the memory 130. The AI model 410, the loss meter 470, and the AI model learner 480 may include instructions executable by the processor 120. In an embodiment, the AI model 410 may include an encoder 420, a mask generator 430, and a domain converter 440.

In an embodiment, the encoder 420 may convert the input audio signal 341 in the time domain into an audio signal in latent domain. In an embodiment, the encoder 420 may convert the input audio signal 341 in the time domain into the audio signal in the latent domain using a designated number of layers (or convolution layers). In an embodiment, the latent domain may be a domain different from the time domain or the frequency domain.

In an embodiment, the encoder 420 may convert a plurality of sample signals in the time domain divided by a designated second window length into audio signals in the latent domain. In an embodiment, the second window length may be shorter than the first window length. In particular, in order to preserve more spatial information (or spatial characteristics) of the input audio signal 341, the second window length may be shorter than the first window length. Accordingly, a length (or frame length) of the sample signal converted from the time domain to the latent domain through the encoder 420 may be shorter than a length (or frame length) of the sample signal converted from the time domain to the frequency domain through the Fourier transformer 401. The spatial information may include information such as a position of a sound source, a time delay, and/or a phase delay of the sample signal. In other words, the sampling rate in the latent domain is higher than the sampling rate of the frequency domain.

In an embodiment, the mask generator 430 may include a plurality of parameters related to a neural network having a structure based on an encoder and a decoder, such as a transformer. In an embodiment, the mask generator 430 may include parameters for driving a neural network such as a convolutional neural network (CNN), a recurrent neural network (RNN), a temporal convolution network (TCN), a feedforward neural network (FNN), and/or long short-term memory (LSTM). However, it is not limited thereto. In an embodiment, the mask generator 430 may include a bi-directional model (e.g., bidirectional encoder representations from transformers (BERT)) based on learning about the encoder, or an auto-encoding model (e.g., a diffusion model). In an embodiment, the mask generator 430 may include an auto-regressor model (e.g., a generative pre-trained transformer (GPT)) based on learning about the decoder. In an embodiment, the mask generator 430 may include a sequence-to-sequence model (e.g., stable diffusion, DALL-E 2) based on learning about the encoder and the decoder.

In an embodiment, the mask generator 430 may generate a mask (or filter) in the latent domain based on the audio signal and a parameter 450 in the latent domain. In an embodiment, the mask generator 430 may generate the mask (or filter) in the latent domain with respect to the plurality of sample signals in the latent domain based on the plurality of audio signals and the parameters 450 in the latent domain. In an embodiment, the parameter 450 may be parameters related to a beam and/or parameters related to noise obtained (or generated) from a parameter generator 310, such as the parameter(s) described with respect to Equation 2.

In an embodiment, the domain converter 440 may convert the mask (or filter) in the latent domain generated by the mask generator 430 into a mask (or filter) in the frequency domain. In an embodiment, the domain converter 440 may convert the mask (or filter) with respect to the plurality of sample signals generated by the mask generator 430 into the mask (or filter) in the frequency domain.

In an embodiment, the domain converter 440 may sum (or concatenate) the masks (or filters) in the latent domain generated by the mask generator 430, as much as the number corresponding to a ratio between a length (or a frame length) of sample signal converted from the time domain to the latent domain through the encoder 420, and a length (or a frame length) of sample signal converted from the time domain to the frequency domain through the Fourier transformer 401 (i.e. so that the sample length upon which the masks output by the AI model are based corresponds to the sample length upon which the Fourier transform was based), and convert them to the masks in the frequency domain. In an embodiment, the domain converter 440 may sum (or concatenate) the masks (or filters) in the latent domain generated by the mask generator 430, as much as the number corresponding to a ratio between the length of the designated second window and the length of the designated first window and the number corresponding to a degree to which the designated second window overlaps (or a size of the offset) within the designated first window, and convert them into the masks (or filters) in the frequency domain.

In an embodiment, the operator 403 may apply an output result (or mask) of the artificial intelligence (AI) model 410 to the input audio signal 341 in the frequency domain. In an embodiment, the operator 403 may generate (or obtain) an audio signal in which the beam of the input audio signal 341 is adjusted (i.e. steered or changed) and the noise is reduced, based on the output result (or mask) of the AI model 410 (i.e. a frequency domain AI-adjusted output signal).

In an embodiment, the operator 403 may generate (or obtain) a plurality of sample signals in which the beam of the input audio signal 341 is adjusted (i.e. steered or changed) and the noise is reduced, based on the output result (or mask) of the AI model 410. In an embodiment, output results (or masks) of the AI model 410 applied to the plurality of sample signals may be different from each other. For example, a first output result (or a first mask) applied to a first sample signal may have a value different from a second output result (or a second mask) applied to a second sample signal.

In an embodiment, the inverse Fourier transformer 405 may convert the audio signal in the frequency domain (i.e. a frequency domain AI-adjusted output signal) into an output signal 460 in the time domain (i.e. time domain AI-adjusted output signal). In an embodiment, the Fourier transformer 401 may convert the audio signal in the frequency domain into the output signal 460 in the time domain, based on a designated inverse Fourier transform algorithm (e.g., inverse STFT (ISTFT)). In an embodiment, the inverse Fourier transformer 405 may generate the output signal 460 in the time domain, based the plurality of sample signals in which the beam is adjusted (or steered) (or changed) and the noise is reduced.

In an embodiment, the loss meter 470 may measure a loss (i.e. a difference, an error etc.) between the output signal 460 and the output audio signal 345. In an embodiment, the loss between the output signal 460 and the output audio signal 345 may be based on a signal to noise ratio (SNR) (or a Scale invariant signal to distortion ratio (SI-SDR)) (or a mean square error).

In an embodiment, the AI model learner 480 may train the AI model 410 based on the measured loss. In an embodiment, the AI model learner 480 may train the AI model 410 based on a backpropagation algorithm. For example, the AI model learner 480 may update parameters of the AI model 410, so that the measured loss is less than or equal to a reference loss. For example, the AI model learner 480 may update parameters of the encoder 420, the mask generator 430, and/or the domain converter 440 of the AI model 410, so that the measured loss is less than or equal to the reference loss.

According to an embodiment, an electronic device 101 may train the AI model 410 based on the generated input audio signal 341 and the generated output audio signal 345.

According to an embodiment, the electronic device 101 may train the AI model 410 generating the same mask regardless of audio channels. Accordingly, the electronic device 101 may obtain a stereo audio signal in which a spatial cue is maintained with respect to a sound source in a designated direction (e.g., designated elevation angle φ of designated azimuth angle θ) through the AI model 410.

According to an embodiment, the electronic device 101 may train the AI model 410 through the parameter related to the noise and/or an adjustable direction (e.g., designated elevation angle φ of designated azimuth angle θ). Accordingly, the electronic device 101 may form a sharper (or narrow beamwidth) frequency invariant beam compared to conventional acoustic beamforming. The operation described with reference to FIG. 4 may be performed by the electronic device that will later implement the AI-beamforming or may be performed separately to the electronic device that will perform the actual beamforming and then provided to the electronic device. In other words, the training may be performed by any suitable device and is not limited to being performed by the electronic device that will preformed the beamforming on real audio signals received through the microphones of the electronic device.

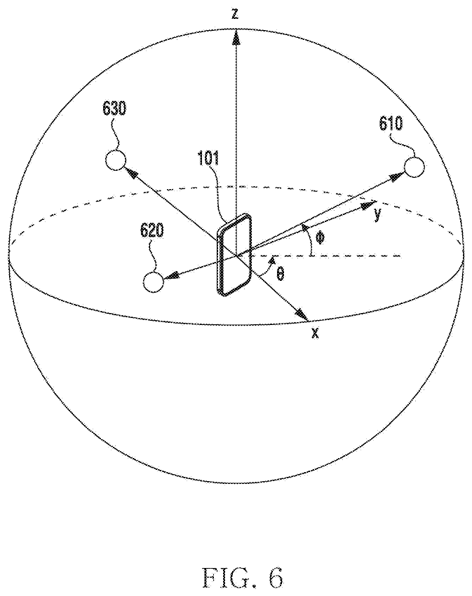

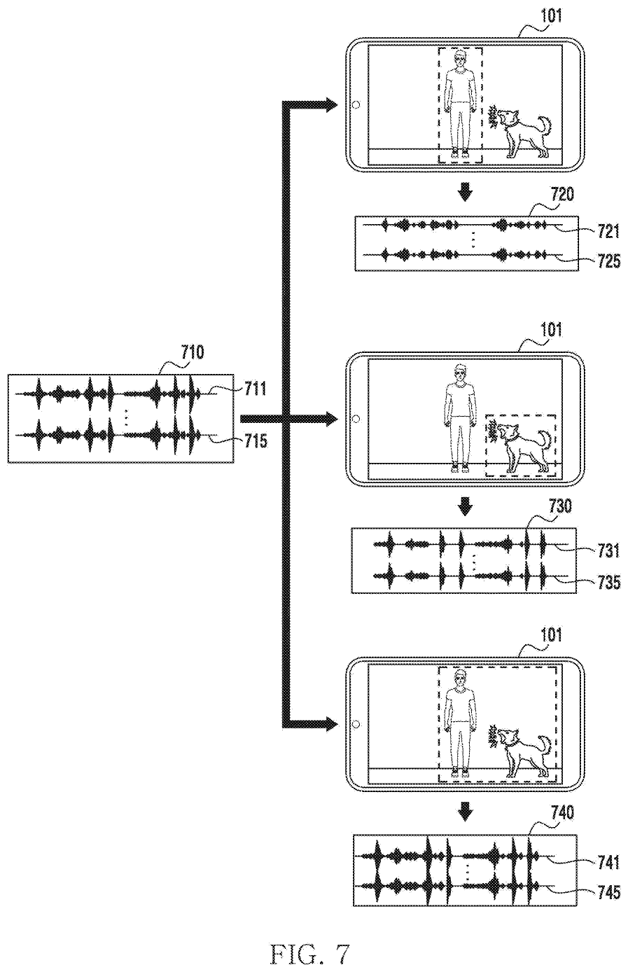

FIG. 5 is a diagram illustrating an operation for acoustic beamforming an audio signal in an electronic device, according to an embodiment. FIG. 6 is a diagram illustrating a three-dimensional space around an electronic device. FIG. 7 is a diagram illustrating an operation of outputting an acoustic beamformed audio signal through an electronic device.

FIG. 5 may be described with reference to FIGS. 1, 2, 3, and 4.

A Fourier transformer 401, an operator 403, and an inverse Fourier transformer 405 illustrated in FIG. 5 may correspond to the Fourier transformer 401, the operator 403, and the inverse Fourier transformer 405 of FIG. 4, respectively. An AI model 410, a loss meter 470, and an AI model learner 480 illustrated in FIG. 5 may correspond to the AI model 410, the loss meter 470, and the AI model learner 480 of FIG. 4, respectively. In an embodiment, the AI model 410 of FIG. 5 may be the AI model 410 trained through a learning operation described through FIG. 4. In the description of FIGS. 5, 6, and 7, the audio signal 501 received through the microphone(s) may be referred to as the input audio signal, received audio signal, the received input audio signal, real input audio signal, or real audio signal. The audio signal 505 may be referred to as the AI-adjusted received audio signal, AI-adjusted output audio signal, AI-beamformed output audio signal, or AI-beamformed audio signal.

In an embodiment, the Fourier transformer 401 may convert the audio signal 501 in the time domain (i.e. time domain received audio signal) into an audio signal in the frequency domain (i.e. frequency domain received audio signal). In an embodiment, the Fourier transformer 401 may convert the audio signal 501 in the time domain into the frequency domain, based on a designated Fourier transform algorithm (e.g., STFT). In an embodiment, the audio signal 501 may include audio signals generated from different sound sources. For example, referring to FIG. 6, an audio signal 501 may include audio signals generated from sound sources 610, 620, and 630 in different directions (e.g., directions according to azimuth angle θ and/or elevation angle φ) in a three-dimensional space.

In an embodiment, the Fourier transformer 401 may convert the audio signal 501 in the time domain into the frequency domain with respect to each of a plurality of sample signals divided by a designated first window length.

In an embodiment, an encoder 420 may convert the audio signal 501 in the time domain into the latent domain. In an embodiment, the encoder 420 may convert the audio signal 501 in the time domain into the latent domain, using a designated number of layers (or convolution layers). In an embodiment, the encoder 420 may convert a plurality of sample signals in the time domain divided by a designated second window length into audio signals in the latent domain. Two consecutive sample signals may overlap each other by an offset. In an embodiment, a time length (or offset) at which two consecutive sample signals overlap may be half of the second window length. However, it is not limited thereto. In an embodiment, the second window length may be shorter than the first window length.

In an embodiment, a mask generator 430 may generate a mask (or filter) in the latent domain based on the latent domain version of audio signal 501 and a parameter 550. In an embodiment, the mask generator 430 may generate the mask (or filter) in the latent domain with respect to the plurality of sample signals in the latent domain based on the plurality of audio signals and the parameters 550 in the latent domain.

In an embodiment, the parameter 550 may be parameters related to a beam and/or a parameter related to noise, identified by an input. For example, the parameter 550 may be identified based on a user input with respect to the electronic device 101. For example, the parameter 550 may be identified based on the user input with respect to the electronic device 101 that selects at least one sound source among sound sources in the three-dimensional space. In an embodiment, the electronic device 101 may identify a position (or direction) in the three-dimensional space of the each of the sound sources, by a time delay and/or a phase delay of the audio signal obtained by a plurality of microphones 271, 273, and 275. The position of the identified position relative to the electronic device may then be used to determine the parameter 550.

For example, the parameter 550 may be identified based on a user input for selecting at least one object among one or more objects included in an image displayed through a display 260 of the electronic device 101. For example, referring to FIG. 7, the electronic device 101 may identify parameters for beamforming for human voice and/or dog sound, based on a user input for selecting a human and/or dog while playing an image related to an audio signal 710 including multi-channel audio signals 711 and 715 with respect to the human voice and the dog sound. For example, based on the user input for selecting the human, the electronic device 101 may identify parameters for beamforming the audio signal 710 including the multi-channel audio signals 711 and 715 into an audio signal 720 including multi-channel audio signals 721 and 725 only for the human voice. For example, based on the user input for selecting the dog, the electronic device 101 may identify parameters for beamforming the audio signal 710 including the multi-channel audio signals 711 and 715 into an audio signal 730 including multi-channel audio signals 731 and 735 only for the dog's sound. For example, based on the user input for selecting the person and the dog, the electronic device 101 may identify parameters for beamforming the audio signal 710 including the multi-channel audio signals 711 and 715 into an audio signal 740 including multi-channel audio signals 741 and 745 for human voice and dog sound. In other words, the position of the selected object (e.g. dog or person) is identified relative to the electronic device and then the beamforming parameters (e.g. beam angles etc.) are identified based on this relative position. However, it is not limited thereto.

In an embodiment, a domain converter 440 may convert a mask (or filter) in the latent domain generated by the mask generator 430 into a mask (or filter) in the frequency domain. In an embodiment, the domain converter 440 may convert a mask (or filter) with respect to a plurality of sample signals generated by the mask generator 430 into the mask (or filter) in the frequency domain.

In an embodiment, the domain converter 440 may sum (or concatenate) the masks (or filters) in the latent domain generated by the mask generator 430, as much as the number corresponding to a ratio between a length (or a frame length) of sample signal converted from the time domain to the latent domain through the encoder 420, and a length (or a frame length) of sample signal converted from the time domain to the frequency domain through the Fourier transformer 401, and convert them to the masks in the frequency domain. In an embodiment, the domain converter 440 may sum (or concatenate) the masks (or filters) in the latent domain generated by the mask generator 430, as much as the number corresponding to a ratio between the length of the designated second window and the length of the designated first window and the number corresponding to a degree to which the designated second window overlaps (or a size of the offset) within the designated first window, and convert them into the masks (or filters) in the frequency domain.

In an embodiment, the operator 403 may apply an output result (or mask) of the artificial intelligence (AI) model 410 to the audio signal 501 in the frequency domain. In an embodiment, the operator 403 may generate (or obtain) an audio signal (i.e. an AI-beamformed output audio signal) in the frequency domain in which the beam of the audio signal 501 is adjusted (i.e. steered, or changed) and the noise is reduced, based on the output result (or mask) of the AI model 410. In an embodiment, the operator 403 may generate (or obtain) a plurality of sample signals in which the beam of the audio signal 501 is adjusted and the noise is reduced, based on the output result (or mask) of the AI model 410.

In an embodiment, the inverse Fourier transformer 405 may convert an audio signal in the frequency domain (i.e. frequency domain AI-adjusted received audio signal) into an audio signal 505 in the time domain (i.e. time domain AI-adjusted received audio signal). In an embodiment, the Fourier transformer 401 may convert the audio signal in the frequency domain into the audio signal 505 in the time domain based on a designated inverse Fourier transform algorithm (e.g., ISTFT). In an embodiment, the inverse Fourier transformer 405 may generate the audio signal 505 in the time domain based on the plurality of sample signals in which the beam is adjusted (or steering) (or changed) and noise is reduced.

According to an embodiment, the electronic device 101 may convert the audio signal 501 (i.e. received audio signal) obtained through a small number of microphones 271, 273, and 275 into the beamformed audio signal 505 (i.e. AI-adjusted received audio signal) through the AI model 410.

According to an embodiment, the electronic device 101 may obtain a stereo audio signal in which a spatial queue is maintained with respect to a sound source in a designated direction (e.g., designated elevation angle Y of designated azimuth angle θ) by applying the same mask generated through the AI model 410 to an audio signal regardless of audio channels.

According to an embodiment, the electronic device 101 may form a sharper (or narrow beamwidth) frequency-invariant beam through a parameter related to the noise and/or a direction adjustable through a user's input (e.g., designated elevation angle φ of designated azimuth angle θ).

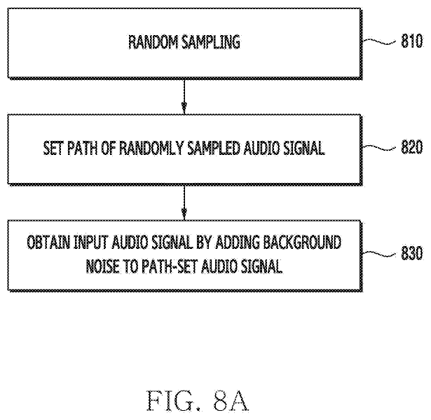

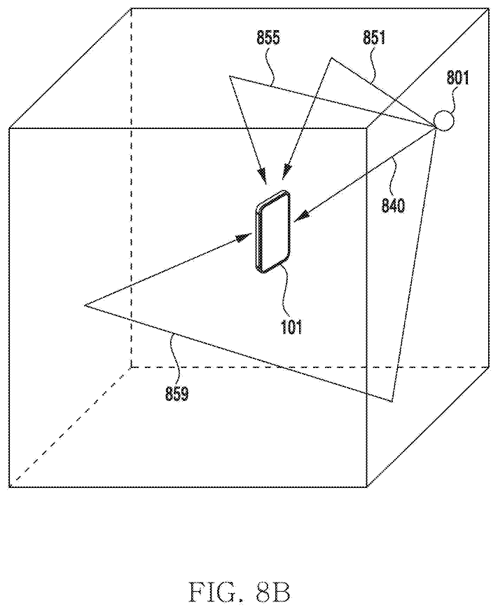

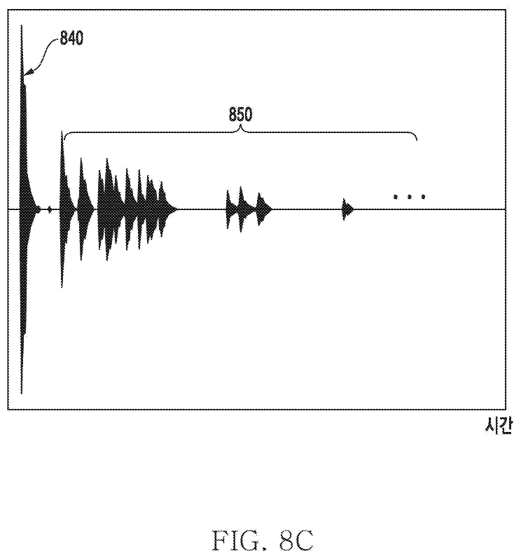

FIG. 8A is a flowchart illustrating an operation in which an electronic device obtains an input audio signal in a similar manner to that described with reference to Equation 1, according to an embodiment. FIG. 8B is a diagram illustrating a path of an audio signal obtained by an electronic device. FIG. 8C is a graph illustrating an audio signal obtained in an electronic device, according to a path of an audio signal.

FIGS. 8A, 8B, and 8C may be described with reference to FIGS. 1, 2, and 3.

Referring to FIG. 8A, in operation 810, an electronic device 101 may perform random sampling. For example, the electronic device 101 may perform random sampling on one or more sound sources among a plurality of sound sources stored in a sound source DB 331. For example, the electronic device 101 may perform random sampling on one or more impulse responses among a plurality of impulse responses stored in a multi-channel impulse response DB 333. For example, the electronic device 101 may perform random sampling on one noise among a plurality of noises stored in a multi-channel noise DB 335.

In operation 820, the electronic device 101 may set a path of a randomly sampled audio signal. In particular, the electronic device 101 may set a direct path and/or one or more reflection paths for each of the one or more sound sources based on the paths randomly selected from the multi-channel impulse response DB. For example, the reflection path may be a path of an audio signal, which is from a position at least partially different with a position of the sound source according to the direct path, to the electronic device 101. In an embodiment, a position of the sound source for the direct path and a position of the sound source for the reflection path may be expressed as azimuth angle θ and elevation angle φ, with respect to the electronic device 101.

In an embodiment, the electronic device 101 may generate a sound signal (hereinafter, direct sound) according to the direct path and reflection signals (e.g., early reflections, and/or late reversals) (hereinafter, reflected sound) according to one or more reflection paths with respect to the direct sound. In an embodiment, the electronic device 101 may generate an audio signal (i.e. noise-free input audio signal) including the direct sound and one or more reflected sounds with respect to the direct sound. Referring to FIG. 8B, an audio signal may include a direct sound 840 according to a direct path from a sound source 801 to the electronic device 101, and reflected sounds 851, 855, and 859 according to paths reflected through a reflector (e.g., a wall, a ceiling, a floor, or an obstacle).

In an embodiment, the electronic device 101 may apply a designated time delay and/or scaling factor to the reflected signal of each of the one or more reflection paths. Referring to FIG. 8C, reflected sounds 850 of an audio signal may be expressed as being obtained after a designated time delay to a plurality of microphones 271, 273, and 275 from the direct sound 840. Referring to FIG. 8C, a size of the reflected sounds 850 of the audio signal may decrease as time passes. In FIG. 8C, the reflected sounds obtained within the designated time from a time at which the direct sound 820 is obtained, may be referred to as early reflections. In FIG. 8C, the reflected sounds obtained after the designated time from a time at which the direct sound 820 is obtained, may be referred to as late reverberations.

In operation 830, the electronic device 101 may obtain an input audio signal by adding background noise to the path-set audio signal. In an embodiment, the electronic device 101 may generate an input audio signal 341 by combining (i.e. synthesizing, convoluting or mixing) noise randomly sampled in the multi-channel noise DB 335 to an audio signal in which the direct sound and the reflected sound have been combined. In an embodiment, the electronic device 101 may generate an input audio signal 341 by combining the noise with the noise-free input audio signal according to a designated signal to noise ratio (SNR). The above described approach for generating input audio signals based on random sampling allows increased numbers of input audio signals to be generated from the sound source DB 331 and the multi-channel impulse response DB 333, thus allows increased volumes of training data to be generated.

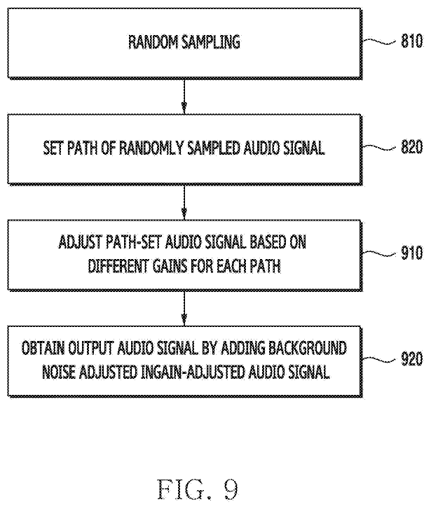

FIG. 9 is a flowchart illustrating an operation in which an electronic device obtains an output audio signal in a similar manner to that described with reference to Equation 3, according to an embodiment.

FIG. 9 may be described with reference to FIGS. 1, 2, and 3. Operation 810 and operation 820 of FIG. 9 may correspond to the operation 810 and the operation 820 of FIG. 8, respectively.

Referring to FIG. 9, in the operation 810, an electronic device 101 may perform random sampling. In the operation 820, the electronic device 101 may set a path of a randomly sampled audio signal.

In operation 910, the electronic device 101 may adjust the path-set audio signal based on different gains for each path. In an embodiment, the electronic device 101 may adjust a direct sound and one or more reflected sounds with respect to the direct sound, based on parameters related to a beam of an audio signal generated (or selected) using a parameter generator 310 to form a noise-free output audio signal. In an embodiment, the electronic device 101 may identify a spatial gain that enables the audio signal to have a direction and beamwidth corresponding to the beam-related parameters. In an embodiment, the electronic device 101 may adjust the direct sound and the one or more reflected sounds with respect to the direct sound by multiplying the spatial gain by the direct sound and the one or more reflected sounds with the direct sound. In an embodiment, the spatial gain may be set to have a high spatial gain for the selected position (or direction) and beamwidth and a low spatial gain for other positions (or directions) and beamwidths.

In operation 920, the electronic device 101 may obtain an output audio signal by adding background noise adjusted in the gain-adjusted audio signal. In an embodiment, the noise in operation 920 may be the same as the noise in operation 830 of FIG. 8, based on a parameter related to noise generated (or selected) using the parameter generator 310, in the electronic device 101. For example, the noise in operation 920 and the noise in operation 830 of FIG. 8 may be noise selected in a multi-channel noise DB 335. For example, the noise in operation 920 may be a noise in which the noise in operation 830 is adjusted based on a parameter related to the noise.

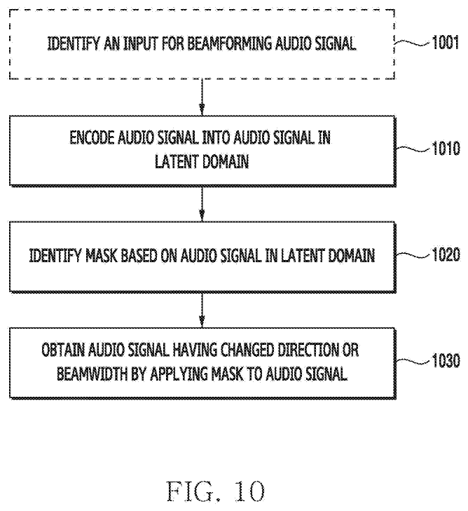

FIG. 10 is a flowchart for describing an operation in which the electronic device performs acoustic beamforming on an audio signal (i.e. received audio signal), according to an embodiment.

FIG. 10 may be described with reference to FIGS. 1, 2, and 5.

Referring to FIG. 10, in operation 1001, an electronic device 101 may identify an input for beamforming an audio signal. For example, the electronic device 101 may identify a user input for selecting at least one sound source among sound sources in a three-dimensional space. For example, the electronic device 101 may identify a user input for selecting at least one object among one or more objects included in an image displayed through a display 260 of the electronic device 101. In an embodiment, the object may be a sound source (or a speaker). However, it is not limited thereto.

In an embodiment, the electronic device 101 may identify a user input for adjusting noise. For example, the electronic device 101 may identify the user input for adjusting the noise through a controllable object (or a visual object) (or bar) on an image displayed through the display 260 of the electronic device 101.

According to an embodiment, operation 1001 may not be performed. For example, the electronic device 101 may determine whether to perform beamforming of an audio signal without an input. For example, the electronic device 101 may determine that beamforming is performed when a plurality of sound sources is included in the audio signal. However, it is not limited thereto.

In operation 1010, the electronic device 101 may encode the audio signal into the audio signal in latent domain. The electronic device 101 may encode the audio signal in time domain into the audio signal in the latent domain.

In an embodiment, the electronic device 101 may convert the audio signal in the time domain into the audio signal in the latent domain, using a designated number of layers (or convolution layers). In an embodiment, the electronic device 101 may convert a plurality of sample signals in the time domain into audio signals in the latent domain.

In operation 1020, the electronic device 101 may identify a mask based on the audio signal in the latent domain.

In an embodiment, the electronic device 101 may generate the mask (or filter) in the latent domain based on the audio signal and a parameter in the latent domain. In an embodiment, the electronic device 101 may generate the mask (or filter) in the latent domain with respect to the plurality of sample signals in the latent domain based on the plurality of audio signals and the parameters in the latent domain.

In an embodiment, the parameter may be parameters related to a beam identified by the user input and/or a parameter related to noise. For example, the parameter may be identified based on a user input to the electronic device 101. For example, the parameter may be identified based on a user input to the electronic device 101 selecting at least one sound source among sound sources in the three-dimensional space and the parameters corresponding a beam directed towards the at least one sound source. For example, the parameter may be identified based on a user input to the electronic device 101 selecting a degree of control of noise.

In operation 1030, the electronic device 101 may obtain an audio signal having a changed direction or beamwidth by applying the mask to the audio signal.

In an embodiment, the electronic device 101 may apply a mask to an audio signal in frequency domain. In an embodiment, the electronic device 101 may generate (or obtain) an audio signal in which the beam of the audio signal is adjusted (or steered) (or changed) and the noise is reduced, based on the mask.

In an embodiment, the electronic device 101 may obtain the mask in the frequency domain through a designated number of masks in the latent domain. In an embodiment, the designated number may correspond to a ratio between a length (or frame length) of the sample signal in the latent domain and a length (or frame length) of the sample signal converted into the frequency domain. In an embodiment, the electronic device 101 may generate (or obtain) an audio signal in which the beam of the audio signal adjusted (or steered) (or changed) and the noise reduced, based on the mask in the frequency domain.

According to an embodiment, an electronic device 101 may comprise a plurality of microphones 271, 273, and 275, a processor 120, and memory 130 storing instructions. The instructions, when executed by the processor 120, may cause the electronic device 101 to encode an input audio signal 501 in time domain obtained through the plurality of microphones 271, 273, and 275 into an audio signal in latent domain. The instructions, when executed by the processor 120, may cause the electronic device 101 to, based on the audio signal in the latent domain, identify a mask for an audio signal in frequency domain with respect to the input audio signal 501. The instructions, when executed by the processor 120, may cause the electronic device 101 to, based on applying the mask to the audio signal in the frequency domain, obtain an output audio signal 505 in the time domain in which at least one of a direction of the input audio signal 501 or beamwidth of the input audio signal 501 is changed.

The instructions, when executed by the processor 120, may cause the electronic device 101 to obtain an input for determining the direction or the beamwidth. The instructions, when executed by the processor 120, may cause the electronic device 101 to identify the mask through an artificial intelligence (AI) model 410, based on the input and the audio signal in the latent domain.

The instructions, when executed by the processor 120, may cause the electronic device 101 to obtain the mask in the frequency domain based on an output mask in the latent domain of the AI model 410. The instructions, when executed by the processor 120, may cause the electronic device 101 to, based on applying the mask in the frequency domain to the audio signal in the frequency domain, obtain the output audio signal 505.

First frame length of the audio signal in the latent domain may be shorter than second frame length of the audio signal in the frequency domain. The instructions, when executed by the processor 120, may cause the electronic device 101 to obtain the mask in the frequency domain, based on a number of the output masks of the AI model 410 corresponding to a ratio between the second frame length and the first frame length.

The electronic device 101 may comprise a camera module 180. The instructions, when executed by the processor 120, may cause the electronic device 101 to obtain an input for selecting at least one object included in an image recorded through the camera module 180. The instructions, when executed by the processor 120, may cause the electronic device 101 to, based on the input, obtain a first parameter for the direction and a second parameter for the beamwidth. The instructions, when executed by the processor 120, may cause the electronic device 101 to obtain the mask by inputting the first parameter, the second parameter, and the audio signal in the latent domain into the AI model 410.

The AI model 410 may be learned by an input audio signal and an output audio signal which is generated based on a parameter indicating beamwidth and a parameter indicating a direction.

The AI model 410 may be learned by the input audio signal and the output audio signal which is generated based on a parameter indicating an adjust degree of noise.

The audio signal in the frequency domain may include sub-audio signals in the frequency domain corresponding to each of a plurality of channels. The instructions, when executed by the processor 120, may cause the electronic device 101 to obtain the output audio signal 505 including sub-audio signals in time domain corresponding to each of the plurality of channels, based on applying the mask to each of the sub-audio signals.

The electronic device 101 may comprise a plurality of speakers 251, 253, and 255. The instructions, when executed by the processor 120, may cause the electronic device 101 to output the output audio signal 505 using the plurality of speakers 251, 253, and 255.

The instructions, when executed by the processor 120, may cause the electronic device 101 to, based on applying the mask to the audio signal in the frequency domain, obtain the output audio signal 505 that noise of the input audio signal 501 is adjusted.

As described above, the electronic device 101 may include a plurality of microphones 271, 273, and 275, a processor 120, and memory 130 for storing instructions. The instructions, when executed by the processor 120, may cause the electronic device 101 to, through AI model 410, obtain an output audio signal 505 in which at least one of a direction of the input audio signal 501 or beamwidth of the input audio signal 501 obtained through a plurality of microphones 271, 273, and 275 is changed. The AI model 410 may be learned by a training output audio signal generated based on a training input audio signal and at least one of parameters among the first parameter indicating the beam width of the audio, or the second parameter indicating the direction of the audio.

The training input audio signal may include a sound source of a direct path, a plurality of early reflections signals with respect to the sound source, a plurality of late reverberations signals with respect to the sound source, and noise. The training output audio signal may be an audio signal in which a gain according to the at least one parameter is applied to the input audio signal.

The AI model 410 may be learned by the training output audio signal generated based on a third parameter indicating an adjust degree of noise.

The AI model 410 may be learned to reduce a difference between the output signal with respect to the input audio signal of the AI model 410 and the output audio signal.

The difference may be a scale invariant signal-to-distortion ratio (SI-SDR) (or a mean square error) between the output signal and the training output audio signal.

As described above, the electronic device 101 may comprise a processor 120, and memory storing a sound source database (DB) 331, a multi-channel impulse response DB 333, a multi-channel noise DB 335, and instructions. The instructions, when executed by the processor 120, may cause the electronic device 101 to select at least one sound signal from the sound source DB 331. The instructions, when executed by the processor 120, may cause the electronic device 101 to, based on the multi-channel impulse response DB 333, generate an audio signal including direct sound and reflected sound with respect to the at least one sound signal. The instructions, when executed by the processor 120, may cause the electronic device 101 to generate an input audio signal in which noise selected based on the multi-channel noise DB 335 and the audio signal are synthesized. The instructions, when executed by the processor 120, may cause the electronic device 101 to generate an output audio signal in which the noise is reduced and at least one of a direction of the audio signal or beamwidth of the input audio signal is changed. The instructions, when executed by the processor 120, may cause the electronic device 101 to train an artificial intelligence (AI) model 410 for a difference between the output audio signal and the output signal with respect to the input audio signal using the AI model 410 to be reduced.

For example, the output audio signal may be a signal in which the noise of the input audio signal is adjusted, based on a parameter indicating a degree of adjustment of the noise

For example, the difference may be a mean square error between the output signal and the training output audio signal.

As described above, the method may be executed by an electronic device 101 including a plurality of microphones 271, 273, and 275. The method may comprise encoding a first audio signal 501 in time domain obtained through the plurality of microphones 271, 273, and 275 into a second audio signal in latent domain. The method may comprise, based on the second audio signal, identifying a mask for a third audio signal in frequency domain of the first audio signal 501. The method may comprise, based on applying the mask to the third audio signal in the frequency domain, obtaining an output audio signal 505 in the time domain in which at least one of a direction of the first audio signal 501 or beamwidth of the first audio signal 501 is changed.

The method may comprise obtaining an input for determining the direction or the beamwidth. The method may comprise identifying the mask through an artificial intelligence (AI) model 410, based on the input and the audio signal in the latent domain.

The audio signal in the frequency domain may include sub-audio signals in the frequency domain corresponding to each of a plurality of channels. The method may comprise obtaining the output audio signal 505 including fourth sub-audio signals corresponding to each of the plurality of channels, based on applying the mask to each of the sub-audio signals.

The electronic device 101 may comprise a plurality of speakers 251, 253, and 255. The method may comprise outputting the output audio signal 505 using the plurality of speakers 251, 253, and 255.

The method may comprise, based on applying the mask to the audio signal in the frequency domain, obtaining the output audio signal 505 that noise of the input audio signal 501 is adjusted.

As described above, the method may be executed by an electronic device 101 including a plurality of microphones 271, 273, and 275. The method may comprise obtaining, an output audio signal 505 in which at least one of a direction of the input audio signal 501 or beamwidth of the input audio signal 501 obtained through a plurality of microphones 271, 273, and 275 is changed. The AI model 410 may be learned by a training output audio signal generated based on a training input audio signal and at least one of parameters among the first parameter indicating the beam width of the audio, or the second parameter indicating the direction of the audio.

As described above, the method may be executed by an electronic device 101 including memory 130 storing a sound source database (DB) 331, a multi-channel impulse response DB 333, and a multi-channel noise DB 335. The method may comprise selecting at least one sound signal from the sound source DB 331. The method may comprise, based on the multi-channel impulse response DB 333, generating an audio signal including direct sound and reflected sound with respect to the at least one sound signal. The method may comprise generating an input audio signal in which noise selected based on the multi-channel noise DB 335 and the audio signal are synthesized. The method may comprise generating an output audio signal in which the noise is reduced and at least one of a direction of the audio signal or beamwidth of the input audio signal is changed. The method may comprise training an artificial intelligence (AI) model 410 for a difference between the output audio signal and the output signal with respect to the input audio signal using the AI model 410 to be reduced.

As described above, the non-transitory computer readable recording medium may store a program including instructions. The instructions, when executed by a processor 120 of an electronic device 101 including a plurality of microphones 271, 273, and 275, may cause the electronic device 101 to encode a first audio signal 501 in time domain obtained through the plurality of microphones into a second audio signal in latent domain. The instructions, when executed by the processor 120, may cause the electronic device 101 to, based on the audio signal in the latent domain, identify a mask for a third audio signal in frequency domain of the first audio signal 501. The instructions, when executed by the processor 120, may cause the electronic device 101 to, based on applying the mask to the audio signal in the frequency domain, obtain an output signal 505 in the time domain in which at least one of a direction of the first audio signal 501 or beamwidth of the first audio signal 501 is changed.

As described above, the non-transitory computer readable recording medium may store a program including instructions. The instructions, when executed by the processor 120 of the electronic device 101 including a plurality of microphones 271, 273, and 275, may cause the electronic device 101 to, through AI model 410, obtain an output audio signal in which at least one of a direction of the input audio signal 501 or beamwidth of the input audio signal 501 obtained through a plurality of microphones 271, 273, and 275 is changed. The AI model 410 may be learned by a training output audio signal generated based on a training input audio signal and at least one of parameters among the first parameter indicating the beam width of the audio, or the second parameter indicating the direction of the audio.

As described above, the non-transitory computer readable recording medium may store a program including instructions. The instructions, when executed by a processor 120 of an electronic device 101 including memory 130 storing a sound source database (DB) 331, a multi-channel impulse response DB 335, a multi-channel noise DB 337, may cause the electronic device 101 to select at least one sound signal from the sound source DB 331. The instructions, when executed by the processor 120, may cause the electronic device 101 to, based on the multi-channel impulse response DB 333, generate an audio signal including direct sound and reflected sound with respect to the at least one sound signal. The instructions, when executed by the processor 120, may cause the electronic device 101 to generate an input audio signal in which noise selected based on the multi-channel noise DB 335 and the audio signal are synthesized. The instructions, when executed by the processor 120, may cause the electronic device 101 to generate an output audio signal in which at least one of a direction of the audio signal or beamwidth of the input audio signal is changed and the noise is reduced. The instructions, when executed by the processor 120, may cause the electronic device 101 to train an artificial intelligence (AI) model 410 for a difference between the output audio signal and the output signal with respect to the input audio signal using the AI model 410 to be reduced.

As described above, the method may be executed by an electronic device 101 including a plurality of microphones 271, 273, and 275. The method may comprise encoding an input audio signal 501 in time domain received through the plurality of microphones 271, 273, and 275 into an input audio signal 501 in a latent domain an input audio signal in time domain received through the plurality of microphones 271, 273, and 275 into an input audio signal in a latent domain. The method may comprise based on the input audio signal in the latent domain, identifying a mask for performing AI-based beamforming on the input audio signal 501. The method may comprise applying the mask to the input audio signal 501 in the frequency domain to obtain an AI-beamformed output audio signal 505 in which at least one of a beamforming direction or a beamforming beamwidth has been applied to the input audio signal 501.

The method may include an operation of obtaining an input for determining the direction and the beamwidth, the beamforming input parameter including the beamforming direction or the beamforming beamwidth. The method may include identifying the mask based on the beamforming input parameter and the input audio signal of the latent region, through an AI (artificial intelligence) model (410) based on the input and the audio signal in the latent domain.

The input audio signal in the frequency domain of the electronic device 101 may include sub-audio signals in the frequency domain corresponding to each of a plurality of channels. The method may comprise obtaining the AI-beamformed output audio signal 505 including sub-audio signals corresponding to each of the plurality of channels, based on applying the mask to each of the sub-audio signals.

The electronic device 101 may comprises a plurality of microphones 271, 273, and 275. The method may comprise outputting the output audio signal 505 using the plurality of microphones 271, 273, and 275.

The method may comprise obtaining the AI beamformed input audio signal (501) in which the noise of the input audio signal (501) is adjusted based on applying the mask to the input audio signal in the frequency domain, and the output audio signal (505) in which the noise of the first input audio signal (501) is adjusted based on applying the mask to the audio signal in the frequency domain.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

The various embodiments described in this disclosure may be combined in any suitable combination unless stated otherwise or incompatible. Embodiments described herein that include multiple features are not limited thereto and features may be removed or introduced unless stated otherwise.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
at least one processor comprising processing circuitry; and
memory comprising one or more storage mediums storing a sound source database (DB), a channel impulse response DB for a plurality of microphones, a channel noise DB, and instructions,
wherein the instructions, when executed by the at least one processor individually or collectively, cause the electronic device to:
select at least one sound signal from the sound source DB,
based on the channel impulse response DB, generate a first audio signal including a direct sound signal and a reflected sound signal with respect to the at least one sound signal,
generate an input audio signal in which noise selected from the channel noise DB and the first audio signal are combined,
generate an output audio signal based on the input audio signal by reducing the noise of the input audio signal and applying at least one of a beamforming direction or a beamforming beamwidth to the first audio signal of the input audio signal,
generate, based on applying an artificial intelligence (AI) model to the input audio signal, an AI-adjusted output audio signal, and
train the AI model based on reducing a difference between the output audio signal and the AI-adjusted output audio signal.

2. The electronic device of claim 1, wherein the output audio signal is a signal in which the noise of the input audio signal is adjusted, based on a parameter indicating a degree of adjustment of the noise.

3. The electronic device of claim 1, wherein the difference is a mean square error between the output audio signal and the AI-adjusted output audio signal.

4. The electronic device of claim 1, wherein applying the AI model to the input audio signal includes applying a mask generated by the AI model to the input audio signal.

5. The electronic device of claim 4, wherein the generating the AI-adjusted output signal includes applying the AI model to the input audio signal in a frequency domain.

6. The electronic device of claim 5, wherein the mask is generated by the AI model in a latent domain different to a time domain and the frequency domain based on the input audio signal.

7. The electronic device of claim 6, wherein a sampling rate of the latent domain is higher than a sampling rate of the frequency domain.

8. The electronic device of claim 1, comprising:
a plurality of microphones,
wherein the instructions, when executed by the at least one processor individually or collectively, cause the electronic device to:
apply the trained the AI model to an input signal received through the plurality of microphones to obtain an AI-beamformed input signal.

9. An electronic device, comprising:
a plurality of microphones;
at least one processor comprising processing circuitry; and
memory comprising one or more storage mediums instructions,
wherein the instructions, when executed by the at least one processor individually or collectively, cause the electronic device to:
encode an input audio signal in time domain received through the plurality of microphones into an input audio signal in a latent domain,
based on the input audio signal in the latent domain, identify a mask for performing artificial intelligence (AI)-based beamforming on the input audio signal, and
apply the mask to the input audio signal in the frequency domain to obtain an AI-beamformed input audio signal in which at least one of a beamforming direction or a beamforming beamwidth has been applied to the input audio signal.

10. The electronic device of claim 9, wherein the instructions, when executed by the at least one processor individually or collectively, cause the electronic device to:
obtain a beamforming input parameter including the beamforming direction or the beamforming beamwidth; and
identify the mask based on the beamforming input parameter and the input audio signal in the latent domain.

11. The electronic device of claim 10, wherein the instructions, when executed by the at least one processor individually or collectively, cause the electronic device to:
convert the mask into the frequency domain for applying to the input audio signal in the frequency domain.

12. The electronic device of claim 11,
wherein a first frame length of the input audio signal in the latent domain is shorter than a second frame length of the input audio signal in the frequency domain, and
wherein the instructions, when executed by the at least one processor individually or collectively, cause the electronic device to:
convert the mask to the frequency domain based on a number of masks corresponding to a ratio between the second frame length and the first frame length.

13. The electronic device of claim 10, comprising: a camera module, wherein the instructions, when executed by the at least one processor individually or collectively, cause the electronic device to:
obtain an input for selecting at least one object included in an image recorded through the camera module;
based on the input, obtain the beamforming input parameter; and
identify the mask in the latent domain based on the beamforming input parameter.

14. The electronic device of claim 9, wherein the instructions, when executed by the at least one processor individually or collectively, cause the electronic device to:
convert the audio input signal into the frequency domain for applying the mask; and
convert the AI-beamformed input audio signal in the frequency domain into the time domain.

15. The electronic device of claim 9, wherein the AI model is trained based on an artificial input audio signal and an artificial output audio signal, wherein the artificial output audio signal is generated by applying a beamforming parameter indicating a beamwidth and a direction to the artificial input audio signal.

16. A method of an electronic device comprising a sound source database (DB), a channel impulse response DB for a plurality of microphones, a channel noise DB, the method comprising:
selecting at least one sound signal from the sound source DB;
based on the channel impulse response DB, generating a first audio signal including a direct sound signal and a reflected sound signal with respect to the at least one sound signal;
generating an input audio signal in which noise selected from the channel noise DB and the first audio signal are combined;
generating an output audio signal based on the input audio signal by reducing the noise of the input audio signal and applying at least one of a beamforming direction or a beamforming beamwidth to the first audio signal of the input audio signal;
generating, based on applying an artificial intelligence (AI) model to the input audio signal, an AI-adjusted output audio signal; and
training the AI model based on reducing a difference between the output audio signal and the AI-adjusted output audio signal.

17. The method of claim 16, wherein the output audio signal is a signal in which the noise of the input audio signal is adjusted, based on a parameter indicating a degree of adjustment of the noise.

18. The method of claim 16, wherein the difference is a mean square error between the output audio signal and the AI-adjusted output audio signal.

19. The method of claim 16, wherein applying the AI model to the input audio signal includes applying a mask generated by the AI model to the input audio signal.

20. The method of claim 19, wherein the generating the AI-adjusted output signal includes applying the AI model to the input audio signal in a frequency domain.
